(19) United States
(12) Patent Application Publication
(10) Pub. No.: US 2026/0321181 A1
(43) Pub. Date: Oct. 15, 2026

(54) DISPLAY PANEL, METHOD FOR CONTROLLING DISPLAY, AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Huijuan YANG, Beijing (CN); Xiaoqing SHU, Beijing (CN); Liheng WEI, Beijing (CN); Hongwei MA, Beijing (CN); Yi ZHANG, Beijing (CN)

(21) Appl. No.: 19/485,407

(22) PCT Filed: Apr. 18, 2024
(86) PCT No.: PCT/CN2024/088534

§ 371 Date: Nov. 18, 2025

(30) Foreign Application Priority Data
May 23, 2023 (CN) 202310587475.4
Jun. 5, 2023 (CN) 202310656740.X

(51) Int. Cl. G09G 3/20; G09G 3/3225

(52) U.S. Cl. CPC G09G 3/2092; G09G 3/3225; G09G 2300/0408; G09G 2300/0819; G09G 2300/0842; G09G 2310/08; G09G 2320/0247

(57) ABSTRACT

Provided is a display panel, including: a timing control module, a pixel array, and a data signal drive module, wherein each pixel unit in the pixel array includes a light-emitting device and a pixel drive circuit configured to drive the light-emitting device to emit light, the timing control module is configured to send a display enable signal to the data signal drive module, and the display enable signal is configured to control the data signal drive module to be powered on and output pixel data of at least one frame of a black image.

### CROSS-REFERENCE TO RELATED APPLICATION

This application is a U.S. national stage of international application No. PCT/CN2024/088534, filed on Apr. 18, 2024, which claims priority to Chinese Patent Application No. 202310587475.4, filed on May 23, 2023 and Chinese Patent Application No. 202310656740.X, filed on Jun. 5, 2023, the contents of which are incorporated herein by reference in their entireties.

### TECHNICAL FIELD

The present disclosure relates to the field of display technologies, and particularly relates to, a display panel, a method for controlling display, and a display device.

### BACKGROUND

In practical applications, whether a light-emitting device emits light is typically controlled by a pixel drive circuit. The pixel drive circuit is typically implemented through a plurality of switching devices. Under the control of control signals, the switching devices cooperate with each other to form a power supply loop between a power source and the light-emitting device, thereby achieving an effect of driving the light-emitting device to emit light.

### SUMMARY

The present disclosure provides a display panel, a method and an apparatus for controlling display, and a display device.

According to some embodiments of the present disclosure, a display panel is provided. The display panel includes: a timing control module, a pixel array, and a data signal drive module, wherein each pixel unit in the pixel array includes a light-emitting device and a pixel drive circuit configured to drive the light-emitting device to emit light, the timing control module is configured to send a display enable signal to the data signal drive module, and the display enable signal is configured to control the data signal drive module to be powered on and output pixel data of at least one frame of a black image.

In some embodiments, the timing control module is further configured to, in response to sending the display enable signal, control an initialization signal line in the pixel drive circuit of each pixel unit to be powered on, and control a level of the initialization signal line to be at a first level.

In some embodiments, the display panel further includes a scan signal drive module, wherein the scan signal drive module includes a light-emitting control signal generation circuit; the timing control module is further configured to, prior to sending the display enable signal to the data signal drive module, control an enable signal line of the light-emitting control signal generation circuit to be powered on and transmit a second level signal; and the timing control module is further configured to, upon the data signal drive module outputting the pixel data of the at least one frame of the black image, control the enable signal line of the light-emitting control signal generation circuit to transmit the clock pulse signal.

In some embodiments, the timing control module is further configured to, in response to controlling the enable signal line of the light-emitting control signal generation circuit to transmit the second level signal, control a clock signal line of the light-emitting control signal generation circuit to be powered on and transmit the first level signal for at least one scan period; and the timing control module is further configured to, prior to sending the display enable signal to the data signal drive module, control the clock signal line of the light-emitting control signal generation circuit to transmit the clock pulse signal.

In some embodiments, the timing control module is further configured to, in response to the enable signal line of the light-emitting control signal generation circuit being powered on, control a reset signal line of the light-emitting control signal generation circuit to transmit the first level signal for at least one scan period; and the timing control module is further configured to control the reset signal line of the light-emitting control signal generation circuit to transmit the second level signal, wherein a time of the reset signal line transmitting the second level signal is earlier than a time of the display enable signal being sent to the data signal drive module.

In some embodiments, the scan signal drive module includes a first reset control signal generation circuit, wherein the first reset control signal generation circuit and the light-emitting control signal generation circuit are identical in circuit structure; the timing control module is further configured to control an enable signal line, a clock signal line and a reset signal line of the first reset control signal generation circuit to be powered on; and power-on timings at least one pair of: the enable signal line of the first reset control signal generation circuit and the enable signal line of the light-emitting control signal generation circuit, the clock signal line of the first reset control signal generation circuit and the clock signal line of the light-emitting control signal generation circuit, and the reset signal line of the first reset control signal generation circuit and the reset signal line of the light-emitting control signal generation circuit are identical.

In some embodiments, the scan signal drive module includes a second reset control signal generation circuit, wherein the second reset control signal generation circuit and the light-emitting control signal generation circuit are identical in circuit structure; the timing control module is further configured to control an enable signal line, a clock signal line and a reset signal line of the second reset control signal generation circuit to be powered on; and power-on timings of at least one pair of: the enable signal line of the second reset control signal generation circuit and the enable signal line of the light-emitting control signal generation circuit, the clock signal line of the second reset control signal generation circuit and the clock signal line of the light-emitting control signal generation circuit, and the reset signal line of the second reset control signal generation circuit and the reset signal line of the light-emitting control signal generation circuit are identical.

In some embodiments, the scan signal drive module includes a first write signal generation circuit; the timing control module is further configured to control an enable signal line of the first write signal generation circuit to be powered on and transmit a first level signal, wherein a time of the enable signal line of the first write signal generation circuit transmitting the first level signal is earlier than a time of the display enable signal being sent to the data signal drive module; and the timing control module is further configured to, upon the data signal drive module outputting the pixel data of the at least one frame of the black image, control the enable signal line of the first write signal generation circuit to transmit the clock pulse signal.

In some embodiments, the timing control module is further configured to, upon controlling the enable signal line of the first write signal generation circuit to be powered on, control a first clock signal line of the first write signal generation circuit to transmit the first level signal for at least one scan period and control a second clock signal line of the first write signal generation circuit to transmit the second level signal for at least one scan period; and the timing control module is further configured to control the first clock signal line and the second clock signal line of the first write signal generation circuit to transmit clock pulse signals, wherein a time of the first clock signal line of the first write signal generation circuit starting to transmit the clock pulse signal and a time of the second clock signal line of the first write signal generation circuit starting to transmit the clock pulse signal are earlier than a time of the display enable signal being sent to the data signal drive module.

In some embodiments, the timing control module is further configured to, upon the enable signal line of the first write signal generation circuit being powered on, control a reset signal line of the first write signal generation circuit to transmit the second level signal.

In some embodiments, the display panel further includes a scan signal drive module, wherein the scan signal drive module includes a second write signal generation circuit; the timing control module is further configured to control an enable signal line of the second write signal generation circuit to be powered on and the enable signal line to transmit a second level signal, wherein a power-on time of the enable signal line of the second write signal generation circuit is earlier than a time of the display enable signal being sent to the data signal drive module; and the timing control module is further configured to, upon the data signal drive module outputting the pixel data of the at least one frame of the black image, control the enable signal line of the second write signal generation circuit to transmit a clock pulse signal, wherein a time of the enable signal line of the second write signal generation circuit starting to transmit the clock pulse signal is earlier than the time of the display enable signal being sent to the data signal drive module.

In some embodiments, the timing control module is further configured to, upon the enable signal line of the second write signal generation circuit being powered on for at least one scan period, control a clock signal line of the second write signal generation circuit to transmit the first level signal.

In some embodiments, the display panel further includes a scan signal drive module, wherein the timing control module is further configured to control a first power line of the scan signal drive module to transmit a second level signal; the timing control module is further configured to control a second power line of the scan signal drive module to transmit a first level signal; and the first power line and the second power line are powered on simultaneously, earlier than a power-on time of a clock signal line of the scan signal drive module.

In some embodiments, the timing control module is further configured to control a first drive power line in the pixel drive circuit of each pixel unit to be powered on and transmit a second level signal; the timing control module is further configured to control a second drive power line in the pixel drive circuit of each pixel unit to be powered on and transmit a first level signal; and a power-on time of the first drive power line and a power-on time of the second drive power line are later than a time of a clock signal line in the pixel drive circuit of each pixel unit staring to transmit a clock pulse signal.

In some embodiments, the timing control module is further configured to control a first pixel data power line to be powered on and transmit a first preset level signal, and control a second pixel data power line to be powered on and transmit a second preset level signal; and a power-on time of the first pixel data power line and a power-on time of the second pixel data power line are at least two scan periods earlier than a power-on time of an enable signal line of a light-emitting control signal generation circuit.

According to some embodiments of the present disclosure, a method for controlling display is provided. The method is applicable to a display panel; the display panel includes: a timing control module, a pixel array, and a data signal drive module, wherein each pixel unit in the pixel array includes a light-emitting device and a pixel drive circuit configured to drive the light-emitting device to emit light; and the method includes: sending a display enable signal to the data signal drive module, wherein the display enable signal is configured to control the data signal drive module to be powered on and output pixel data of at least one frame of a black image.

In some embodiments, the display panel further includes a scan signal drive module, the scan signal drive module including a light-emitting control signal generation circuit and a first write signal generation circuit; and the method further includes: prior to sending the display enable signal to the data signal drive module, controlling an enable signal line of the light-emitting control signal generation circuit to be powered on and transmitting a second level signal; upon the data signal drive module outputting the pixel data of the at least one frame of the black image, controlling the enable signal line of the light-emitting control signal generation circuit to transmit a clock pulse signal; in response to the enable signal line of the light-emitting control signal generation circuit being powered on, controlling a reset signal line of the light-emitting control signal generation circuit to transmit a first level signal for at least one scan period; controlling the reset signal line of the light-emitting control signal generation circuit to transmit the second level signal, wherein a time of the reset signal line transmits the second level signal is earlier than a time of the display enable signal being sent to the data signal drive module; controlling an enable signal line of the first write signal generation circuit to be powered on and transmitting the first level signal, wherein a time of the enable signal line of the first write signal generation circuit transmitting the first level signal is earlier than the time of the display enable signal being sent to the data signal drive module; and upon the data signal drive module outputting the pixel data of at least one frame of the black image, controlling the enable signal line of the first write signal generation circuit to transmit the clock pulse signal.

In some embodiments, the method further includes: in response to the enable signal line of the light-emitting control signal generation circuit being controlled to transmit the second level signal, controlling a clock signal line of the light-emitting control signal generation circuit to be powered on and transmitting the first level signal for at least one scan period; and prior to sending the display enable signal to the data signal drive module, controlling the clock signal line of the light-emitting control signal generation circuit to transmit the clock pulse signal.

According to some embodiments of the present disclosure, an apparatus for controlling display is provided. The apparatus is applicable to a display panel, and the display panel includes a timing control module, a pixel array, and a data signal drive module; wherein each pixel unit in the pixel array includes a light-emitting device and a pixel drive circuit configured to drive the light-emitting device to emit light, and the apparatus includes: a display enable signal sending module, configured to send a display enable signal to the data signal drive module, wherein the display enable signal is configured to control the data signal drive module to be powered on and output pixel data of at least one frame of a black image.

According to some embodiments of the present disclosure, a display device is provided, and includes the display panel according to any one of the above embodiments.

It should be understood that the above general description and the detailed following description are only illustrative and explanatory and cannot limit the present disclosure.

### BRIEF DESCRIPTION OF DRAWINGS

FIG. 1 is a structural block diagram of a display panel according to some embodiments of the present disclosure;

FIG. 2 is a schematic diagram of a pixel drive circuit according to some embodiments of the present disclosure;

FIG. 3 is a schematic diagram of another pixel drive circuit according to some embodiments of the present disclosure;

FIGS. 4 to 8 are circuit diagrams of a scan signal drive module according to some embodiments of the present disclosure; and

FIG. 9 is a power-on timing diagram of a pixel drive circuit according to some embodiments of the present disclosure.

### DETAILED DESCRIPTION

Exemplary embodiments are to be described in detail hereinafter, with examples thereof shown in the accompanying drawings. When the following description refers to the accompanying drawings, the same reference numerals denote the same or similar elements unless otherwise indicated. The implementations described in the following exemplary embodiments do not represent all implementations consistent with the present disclosure. Rather, they are merely examples of apparatuses consistent with some aspects of the present disclosure as detailed in the appended claims.

During a power-on phase of the pixel drive circuit, a phenomenon of improper power-on timing of the control signals causes the light-emitting device to emit light abnormally, i.e., flickering of a display screen, which reduces the use experience.

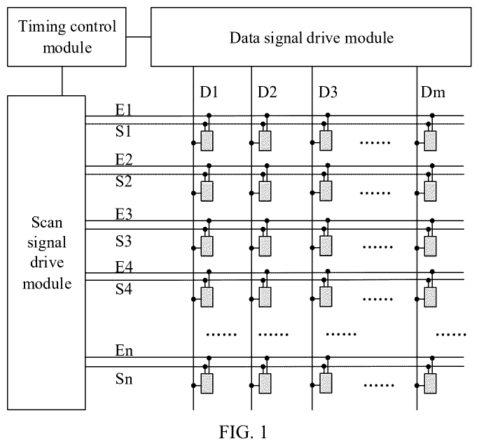

The present disclosure provides a display device, which may include, but is not limited to, devices with display functions such as mobile phones, computers, tablet computers, e-books, watches, stereoscopic displays, conference all-in-one machines, and electronic white boards. The display device includes a display panel. Referring to FIG. 1, the display panel includes a timing control module, a pixel array, a scan signal drive module, and a data signal drive module. Each pixel unit in the pixel array includes a light-emitting device and a pixel drive circuit configured to drive the light-emitting device to emit light. The structure of the light-emitting device of the pixel unit includes various types, which may be selected and set according to actual needs. For example, the above light-emitting device is an organic light-emitting diode (OLED), a quantum dot light-emitting diode (QLED), or a micro light-emitting diode (Micro LED), or the like.

In some embodiments, the scan signal drive module includes a first reset control signal generation circuit H GOA, a second reset control signal generation circuit P GOA, a first write signal generation circuit Ngate GOA, a second write signal generation circuit Gate GOA, and a light-emitting control signal generation circuit EM GOA.

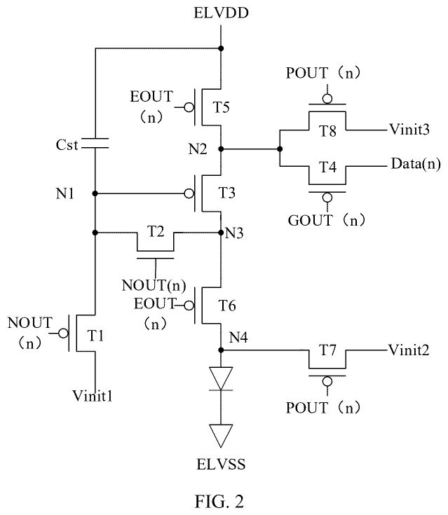

In some embodiments, the pixel drive circuit are different in circuit structure. For example, the pixel drive circuit is implemented with an 8T-1C circuit structure as shown in FIG. 2. A person skilled in the art selects an appropriate circuit structure according to specific scenarios to implement the method provided by the solutions of the present disclosure.

Taking the pixel drive circuit shown in FIG. 2 as an example, referring to FIG. 2, the pixel drive circuit includes switching devices T1 to T8 and a storage capacitor Cst. A control signal for the first switching device 1 in the pixel drive circuit is provided by the second reset control signal generation circuit P GOA. A control signal for the second switching device T2 in the pixel drive circuit is provided by the first write signal generation circuit Ngate GOA. A control signal for the fourth switching device T4 in the pixel drive circuit is provided by the second write signal generation circuit Gate GOA. A control signal for the fifth switching device T5 in the pixel drive circuit is provided by the light-emitting control signal generation circuit EM GOA. A control signal for the sixth switching device T6 in the pixel drive circuit is provided by the light-emitting control signal generation circuit EM GOA. A control signal for the seventh switching device T7 in the pixel drive circuit is provided by the first reset control signal generation circuit H GOA. A control signal for the eighth switching device T8 in the pixel drive circuit is provided by the first reset control signal generation circuit H GOA.

In some embodiments, the light-emitting control signal generation circuit EM GOA is implemented with a circuit structure such as 10T-3C, 12T-3C, 13T-3C, or 16T-3C. In an example, taking 13T-3C as an example, the circuit of the light-emitting control signal generation circuit EM GOA is shown in FIG. 4, and an output terminal of the light-emitting control signal generation circuit is denoted as EOUT.

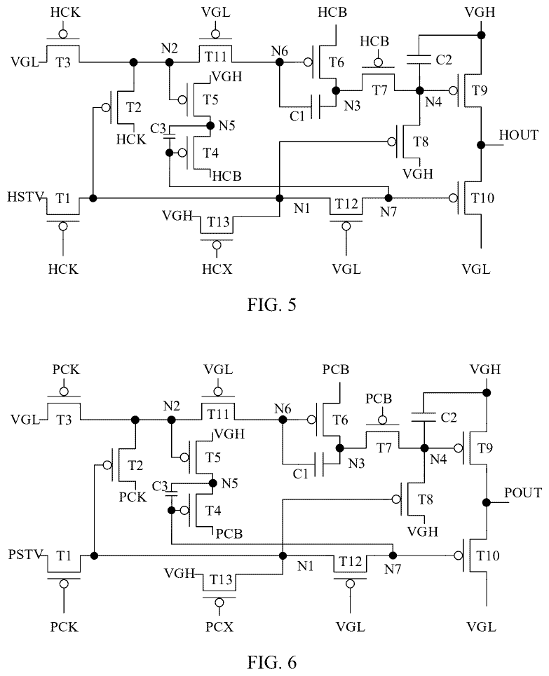

In some embodiments, the first reset control signal generation circuit H GOA is implemented with a circuit structure such as 10T-3C, 12T-3C, 13T-3C, or 16T-3C. In an example, the first reset control signal generation circuit H GOA and the light-emitting control signal generation circuit EM GOA are identical in circuit structure. The circuit is shown in FIG. 5, and an output terminal of the first reset control signal generation circuit H GOA is denoted as HOUT.

In some embodiments, the second reset control signal generation circuit P GOA is implemented with a circuit structure such as 10T-3C, 12T-3C, 13T-3C, or 16T-3C. In an example, the second reset control signal generation circuit P GOA and the light-emitting control signal generation circuit EM GOA are identical in circuit structure. The circuit is shown in FIG. 6, and an output terminal of the second reset control signal generation circuit P GOA is denoted as POUT.

In some embodiments, the first write signal generation circuit Ngate GOA is implemented with a circuit structure such as 10T-3C, 12T-3C, 13T-3C, or 16T-3C. In an example, the first write signal generation circuit Ngate GOA and the light-emitting control signal generation circuit EM GOA are identical in circuit structure. The circuit is shown in FIG. 7, and the output terminal of the first write signal generation circuit Ngate GOA is denoted as NOUT.

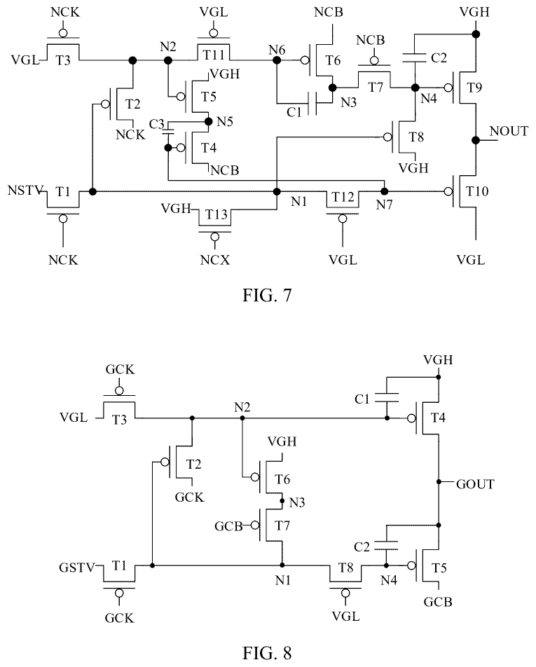

In some embodiments, the second write signal generation circuit Gate GOA is implemented with an 8T-2C circuit. The circuit is shown in FIG. 8, and an output terminal of the second write signal generation circuit Gate GOA is denoted as GOUT.

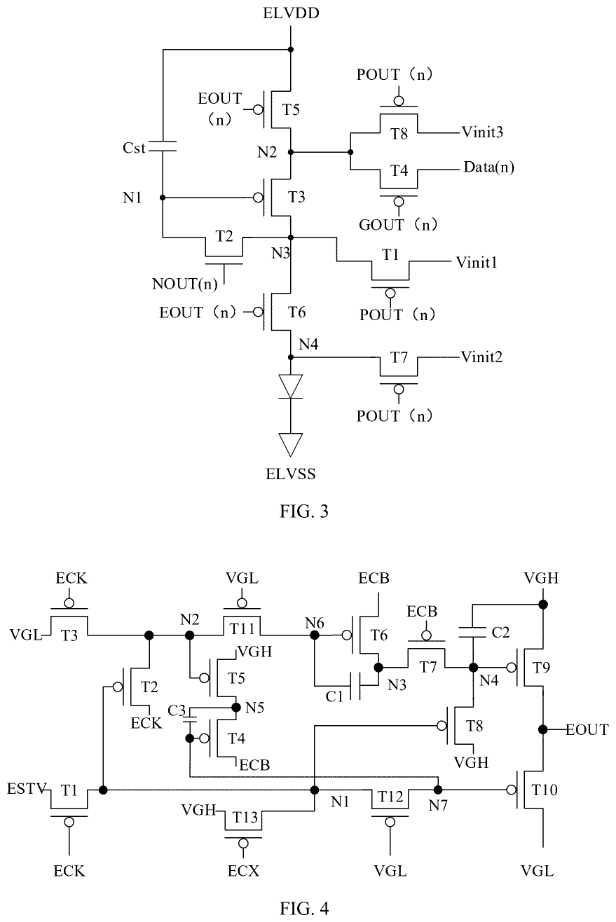

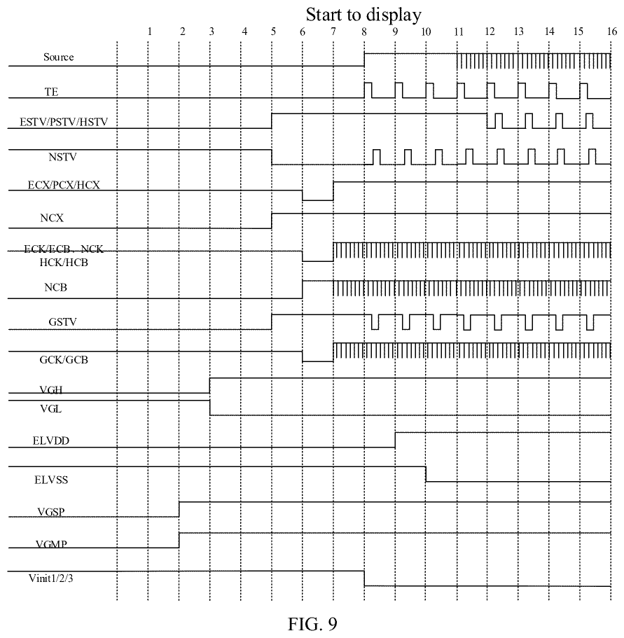

To facilitate description of the solutions, the switching devices in FIGS. 2 to 8 are implemented with P-type switching devices, that is, the turn-on voltage for a P-type switching device is a low level. The switching device T2 in the circuit shown in FIGS. 2 and 3 is implemented with an N-type switching device, that is, the turn-on voltage for the N-type switching device is a high level. Moreover, in the subsequent embodiments, corresponding circuit structures are set with a first level as the low level and a second level as the high level as an example. controlling the display panel to display an image, with the timing control module as the execution entity, according to the control timing shown in FIG. 9 includes: sending, by the timing control module, a display enable signal to a data signal drive module. The display enable signal is configured to control the data signal drive module to be powered on, that is, a display device starts to display the image. In addition, upon being powered on, the data signal drive module (denoted as Source in FIG. 9) outputs pixel data of at least one frame of a black image. The value range for the number of black images is 1 to 10. In an example, the number of the black images is 3.

Thus, according to the solutions of embodiments of the present disclosure, the display device is enabled to display the black image for at least one frame, such that a display screen can still display black in the case that the scan signal drive module malfunctions, thereby avoiding a flickering problem of the display screen, and improving user experience.

In some embodiments, in response to sending the display enable signal TE, the timing control module controls an initialization signal line in the pixel drive circuit of each pixel unit to be powered on, and the level of the initialization signal line is a low level. Continuing to refer to FIGS. 2 and 9, the initialization signal lines include an initialization signal line init1, an initialization signal line init2, and an initialization signal line init3, which respectively transmit level signals Vinit1, Vinit2, and init3. In an example, voltages of the above level signals init1, Vinit2, and Vinit3 are equal, all being level signals with voltages below 0V. In addition, the timing control module may control the data signal drive module and all the initialization signal lines (i.e., initialization signal line init1, initialization signal line init2, and initialization signal line init3) to be powered on simultaneously.

It can be understood that each pixel drive circuit typically is provided with an initialization phase prior to driving the light-emitting device to emit light, so as to perform an initialization operation on potentials of nodes N1, N2, N3, and N4 in FIG. 2. In the embodiment, by controlling the data signal drive module and all the initialization signal lines to be powered on simultaneously, the normal operation of the pixel drive circuit can be ensured, without wasting electric energy.

In some embodiments, prior to sending the display enable signal to the data signal drive module, the timing control module controls the enable signal line ESTV of the light-emitting control signal generation circuit to be powered on and transmits a high-level signal. In addition, upon the data signal drive module outputting the pixel data of the at least one frame of the black image, the timing control module controls the enable signal line ESTV of the light-emitting control signal generation circuit to transmit a clock pulse signal.

Continuing to refer to FIGS. 4 and 9, in an example, the timing control module first controls the enable signal line ESTV of the light-emitting control signal generation circuit EM GOA to be powered on. At this point, the enable signal line ESTV of the light-emitting control signal generation circuit EM GOA transmits a high-level signal. In the case that three scan periods following power-on, the timing control module controls the data signal drive module to be powered on. Upon being powered on, the data signal drive module first outputs pixel data for three frames of black images, and then outputs pixel data of an actual display image. Then, the timing control module controls the enable signal line ESTV of the light-emitting control signal generation circuit EM GOA to transmit a clock pulse signal.

In this way, in the embodiment, by powering on the enable signal line ESTV and transmitting the high-level signal, in response to switching devices T1 and T12 in the light-emitting control signal generation circuit EM GOA being turned on, potentials at the nodes N1 and N7 are set to a high level, thereby turning off the switching device T10 in the light-emitting control signal generation circuit EM GOA. Accordingly, the output terminal OUT of the light-emitting control signal generation circuit EM GOA outputs the high-level signal. Because the switching devices T5 and T6 in the pixel drive circuit are controlled by the output signal of the light-emitting control signal generation circuit EM GOA, at this point, the switching devices T5 and T6 in the pixel drive circuit remain turned off, which prevents the power signal from the first drive power line ELVDD from being transmitted to the light-emitting device, i.e., a screen flickering problem of the display panel is avoided.

In some embodiments, in response to controlling the enable signal line ESTV of the light-emitting control signal generation circuit EM GOA to transmit the high-level signal, the timing control module controls the clock signal line ECK/ECB of the light-emitting control signal generation circuit to be powered on and transmits a low-level signal for at least one scan period. Prior to sending the display enable signal TE to the data signal drive module, the timing control module controls the clock signal line ECK/ECB of the light-emitting control signal generation circuit EM GOA to transmit a clock pulse signal.

Continuing to refer to FIGS. 4 and 9, in an example, the timing control module first controls the enable signal line ESTV of the light-emitting control signal generation circuit EM GOA to be powered on. At this point, the enable signal line ESTV of the light-emitting control signal generation circuit EM GOA transmits a high-level signal. Then, the timing control module controls the clock signal line ECK/ECB of the light-emitting control signal generation circuit EM GOA to be powered on and transmits a low-level signal. At this point, the switching devices T1 and T12 in the light-emitting control signal generation circuit EM GOA are in the on state. The high-level signal transmitted by the enable signal line ESTV is written into the nodes N1 and N7, thereby turning off a switching device T10 in the light-emitting control signal generation circuit EM GOA, that is, the light-emitting control signal generation circuit EM GOA cannot output a low-level signal, i.e., outputs a high-level signal. At this point, the switching devices T5 and T6 in the pixel drive circuit remain turned off, which prevents the power signal from the first drive power line ELVDD from being transmitted to the light-emitting device, i.e., a screen flickering problem of the display panel is avoided.

In some embodiments, in response to controlling the enable signal line ESTV of the light-emitting control signal generation circuit EM GOA to be powered on, the timing control module controls the reset signal line ECX of the light-emitting control signal generation circuit to be powered on and transmits a low-level signal for at least one scan period. Then, the timing control module controls the reset signal line ECX of the light-emitting control signal generation circuit to transmit a high-level signal. The time of the reset signal line ECX transmits the high-level signal being earlier than the time of the display enable signal TE being sent to the data signal drive module or earlier than the power-on time of the data signal drive module.

Continuing to refer to FIGS. 4 and 9, in an example, the timing control module first controls the enable signal line ESTV of the light-emitting control signal generation circuit EM GOA to be powered on. At this point, the enable signal line ESTV of the light-emitting control signal generation circuit EM GOA transmits a high-level signal. Then, the timing control module controls the reset signal line ECX of the light-emitting control signal generation circuit EM GOA to be powered on and transmits a low-level signal. At this point, a switching device T13 in the light-emitting control signal generation circuit EM GOA is in the on state, and the high-level signal transmitted by the first power line VGH is written into the nodes N1 and N7, thereby turning off the switching device T10 in the light-emitting control signal generation circuit EM GOA, that is, the light-emitting control signal generation circuit EM GOA cannot output the low-level signal, i.e., outputs the high-level signal. At this point, the switching devices T5 and T6 in the pixel drive circuit remain turned off, which prevents the power signal from the first drive power line ELVDD from being transmitted to the light-emitting device. Afterwards, the timing control module controls the reset signal line ECX of the light-emitting control signal generation circuit EM GOA to transmit the high-level signal. The time of the reset signal line ECX transmitting the high-level signal is earlier than the time of the display enable signal TE being sent to the data signal drive module or earlier than the power-on time of the data signal drive module. Thus, in the embodiment, it can be ensured that the pixel drive circuit cannot output the low-level signal during a certain period prior to display, thereby ensuring that the display panel does not have a screen flickering problem.

In some embodiments, the timing control module controls the enable signal line HSTV, the clock signal line HCK/HCB, and the reset signal line HCX of the first reset control signal generation circuit H GOA to be powered on. The power-on timings of at least one pair of: the enable signal line HSTV of the first reset control signal generation circuit H GOA and the enable signal line ESTV of the light-emitting control signal generation circuit EM GOA, the clock signal line HCK/HCB of the first reset control signal generation circuit H GOA and the clock signal line ECK/ECB of the light-emitting control signal generation circuit EM GOA, and the reset signal line HCX of the first reset control signal generation circuit H GOA and the reset signal line ECX of the light-emitting control signal generation circuit EM GOA are identical.

The first reset control signal generation circuit H GOA and the light-emitting control signal generation circuit EM GOA are identical in circuit structure, and at least one pair of corresponding signal lines in the two circuits have the same power-on timing. For convenience of description, the solution of each embodiment is to be described subsequently by taking an example in which signal lines of the two circuits use the same power-on timing and signals transmitted by the two circuits are the same.

In some embodiments, prior to sending the display enable signal to the data signal drive module, the timing control module controls the enable signal line HSTV of the first reset control signal generation circuit H GOA to be powered on and transmits a high-level signal. In addition, upon the data signal drive module outputting the pixel data of the at least one frame of the black image, the timing control module controls the enable signal line HSTV of the first reset control signal generation circuit H GOA to transmit a clock pulse signal.

Continuing to refer to FIGS. 5 and 9, in an example, the timing control module first controls the enable signal line HSTV of the first reset control signal generation circuit H GOA to be powered on. At this point, the enable signal line HSTV of the first reset control signal generation circuit H GOA transmits a high-level signal. In the case that three scan periods following power-on, the timing control module controls the data signal drive module to be powered on. Upon being powered on, the data signal drive module first outputs pixel data for three frames of black images, and then outputs pixel data for an actual display image. Then, the timing control module controls the enable signal line HSTV of the first reset control signal generation circuit H GOA to transmit a clock pulse signal.

In this way, by powering on the enable signal line HSTV and transmitting the high-level signal, in response to the switching devices T1 and T12 in the first reset control signal generation circuit H GOA being turned on, the potentials at the nodes N1 and N7 are set to a high level, thereby turning off the switching device T10 in the first reset control signal generation circuit H GOA. Accordingly, the output terminal HOUT of the first reset control signal generation circuit H GOA cannot output a low-level signal, i.e., outputs the high-level signal. Because the switching devices T7 and T8 in the pixel drive circuit are controlled by the output signal of the first reset control signal generation circuit H GOA, at this point, the switching devices T7 and T8 in the pixel drive circuit remain turned off, which prevents a noise signal transmitted by the initialization signal lines from being transmitted to the light-emitting device, i.e., a screen flickering problem of the display panel is avoided.

In some embodiments, in response to controlling the enable signal line HSTV of the first reset control signal generation circuit H GOA to transmit the high-level signal, the timing control module controls the clock signal line HCK/HCB of the first reset control signal generation circuit H GOA to be powered on and transmits a low-level signal for at least one scan period. Prior to sending the display enable signal TE to the data signal drive module, the timing control module controls the clock signal line HCK/HCB of the first reset control signal generation circuit H GOA to transmit a clock pulse signal.

Continuing to refer to FIGS. 5 and 9, in an example, the timing control module first controls the enable signal line HSTV of the first reset control signal generation circuit H GOA to be powered on. At this point, the enable signal line HSTV of the first reset control signal generation circuit H GOA transmits a high-level signal. Then, the timing control module controls the clock signal line HCK/HCB of the first reset control signal generation circuit H GOA to be powered on and transmits a low-level signal. At this point, the switching devices T1 and T12 in the first reset control signal generation circuit H GOA are in the on state. The high-level signal transmitted by the enable signal line HSTV is written into the nodes N1 and N7, thereby turning off the switching device T10 in the first reset control signal generation circuit H GOA. The switching devices T3, T11, T6, and T7 in the first reset control signal generation circuit H GOA are turned on. The potentials at the nodes N2, N6, N3 and N4 are low levels. At this point, the switching device T9 is turned on, that is, the first reset control signal generation circuit H GOA outputs the high-level signal. At this point, the switching devices T7 and T8 in the pixel drive circuit remain turned off, which prevents a noise signal transmitted by the initialization signal lines from being transmitted to the light-emitting device, i.e., a screen flickering problem of the display panel is avoided.

In some embodiments, in response to controlling the enable signal line HSTV of the first reset control signal generation circuit H GOA to be powered on, the timing control module controls the reset signal line HCX of the first reset control signal generation circuit H GOA to be powered on and transmits a low-level signal for at least one scan period. Then, the timing control module controls the reset signal line HCX of the first reset control signal generation circuit H GOA to transmit a high-level signal. The time of the reset signal line HCX transmitting the high-level signal is earlier than the time of the display enable signal TE being sent to the data signal drive module or earlier than the power-on time of the data signal drive module.

Continuing to refer to FIGS. 5 and 9, in an example, the timing control module first controls the first reset control signal generation circuit H GOA to be powered on. At this point, the enable signal line HSTV of the first reset control signal generation circuit H GOA may transmit a high-level signal. Then, the timing control module controls the reset signal line HCX of the first reset control signal generation circuit H GOA to be powered on and transmits a low-level signal. At this point, the switching device T13 in the first reset control signal generation circuit H GOA is in the on state, and the high-level signal transmitted by the first power line VGH is written into the nodes N1 and N7, thereby turning off the switching device T10 in the first reset control signal generation circuit H GOA, that is, the first reset control signal generation circuit H GOA cannot output the low-level signal, i.e., outputs the high-level signal. At this point, the switching devices T7 and T8 in the pixel drive circuit remain turned off, preventing a noise signal from the initialization signal lines from being transmitted to the light-emitting device. Afterwards, the timing control module controls the reset signal line HCX of the first reset control signal generation circuit H GOA to transmit the high-level signal. The time of the reset signal line HCX transmitting the high-level signal is earlier than the time of the display enable signal TE being sent to the data signal drive module or earlier than the power-on time of the data signal drive module. Thus, in the present embodiment, it can be ensured that the noise signal on the initialization level line in the pixel drive circuit cannot be transmitted to the light-emitting device during a certain period prior to display, thereby ensuring that the display panel does not have a screen flickering problem.

In some embodiments, the timing control module controls the enable signal line PSTV, the clock signal line PCK/PCB, and the reset signal line PCX of a second reset control signal generation circuit P GOA to be powered on. The power-on timings at least one pair of: the enable signal line PSTV of the second reset control signal generation circuit P GOA and the enable signal line ESTV of the light-emitting control signal generation circuit EM GOA, the clock signal line PCK/PCB of the second reset control signal generation circuit P GOA and the clock signal line PCK/PCB of the light-emitting control signal generation circuit EM GOA, and the reset signal line PCX of the second reset control signal generation circuit P GOA and the reset signal line PCX of the light-emitting control signal generation circuit EM

The second reset control signal generation circuit P GOA and the light-emitting control signal generation circuit EM GOA are identical in circuit structure, and at least one pair of corresponding signal lines in the two circuits have the same power-on timing. For convenience of description, an example in which signal lines of the two circuits use the same power-on timing and signals transmitted by the two circuits are the same is taken for description subsequently.

In some embodiments, prior to sending the display enable signal to the data signal drive module, the timing control module controls the enable signal line PSTV of the second reset control signal generation circuit P GOA to be powered on and transmits a high-level signal. In addition, upon the data signal drive module outputting the pixel data of the at least one frame of the black image, the timing control module controls the enable signal line PSTV of the second reset control signal generation circuit P GOA to transmit a clock pulse signal.

Continuing to refer to FIGS. 6 and 9, in an example, the timing control module first controls the enable signal line PSTV of the second reset control signal generation circuit P GOA to be powered on. At this point, the enable signal line PSTV of the second reset control signal generation circuit P GOA transmits a high-level signal. In the case that three scan periods following power-on, the timing control module controls the data signal drive module to be powered on. Upon being powered on, the data signal drive module first outputs pixel data for three frames of black images, and then outputs pixel data for an actual display image. Then, the timing control module controls the enable signal line PSTV of the second reset control signal generation circuit P GOA to transmit a clock pulse signal.

Thus, by powering on the enable signal line PSTV and transmitting the high-level signal, in response to the switching devices T1 and T12 in the second reset control signal generation circuit P GOA being turned on, the potentials at the nodes N1 and N7 are set to a high level, thereby turning off the switching device T10 in the second reset control signal generation circuit P GOA. Accordingly, the output terminal OUT of the second reset control signal generation circuit P GOA cannot output a low-level signal, i.e., outputs the high-level signal.

Because the switching device Tl in the pixel drive circuit shown in FIG. 3 is controlled by the output signal of the second reset control signal generation circuit P GOA, at this point, the switching device T1 in the pixel drive circuit remains turned off, which prevents the noise signal transmitted by the initialization signal line from being transmitted to the light-emitting device, i.e., a screen flickering problem of the display panel is avoided.

In some embodiments, in response to controlling the enable signal line PSTV of the second reset control signal generation circuit P GOA to transmit the high-level signal, the timing control module controls the clock signal line PCK/PCB of the second reset control signal generation circuit P GOA to be powered on and transmits a low-level signal for at least one scan period. Prior to sending the display enable signal TE to the data signal drive module, the timing control module controls the clock signal line PCK/PCB of the second reset control signal generation circuit P GOA to transmit a clock pulse signal.

Continuing to refer to FIGS. 6 and 9, in an example, the timing control module first controls the enable signal line PSTV of the second reset control signal generation circuit P GOA to be powered on. At this point, the enable signal line PSTV of the second reset control signal generation circuit P GOA transmits a high-level signal. Then, the timing control module controls the clock signal line PCK/PCB of the second reset control signal generation circuit P GOA to be powered on and transmits a low-level signal. At this point, the switching devices T1 and T12 in the second reset control signal generation circuit P GOA are in the on state. The high-level signal transmitted by the enable signal line PSTV is written into the nodes N1 and N7, thereby turning off the switching device T10 in the second reset control signal generation circuit P GOA. The switching devices T3, T11, T6, and T7 in the second reset control signal generation circuit P GOA are turned on, and the potentials at the nodes N2, N6, N3 and N4 are all low levels. At this point, the switching device T9 is turned on, that is, the second reset control signal generation circuit P GOA outputs the high-level signal. At this point, the switching device T1 in the pixel drive circuit shown in FIG. 3 remains turned off, which prevents the noise signal transmitted by the initialization signal line init1 from being transmitted to the light-emitting device, i.e., a screen flickering problem of the display panel is avoided.

In some embodiments, in response to controlling the enable signal line PSTV of the second reset control signal generation circuit P GOA to be powered on, the timing control module controls the reset signal line PCX of the second reset control signal generation circuit P GOA to be powered on and transmits a low-level signal for at least one scan period. Then, the timing control module controls the reset signal line PCX of the second reset control signal generation circuit P GOA to transmit a high-level signal. The time of the reset signal line PCX transmitting the high-level signal is earlier than the time of the display enable signal TE being sent to the data signal drive module or earlier than the power-on time of the data signal drive module.

Continuing to refer to FIGS. 6 and 9, in an example, the timing control module first controls the enable signal line PSTV of the second reset control signal generation circuit P GOA to be powered on. At this point, the enable signal line PSTV of the second reset control signal generation circuit P GOA transmits a high-level signal. Then, the timing control module controls the reset signal line PCX of the second reset control signal generation circuit P GOA to be powered on and transmits a low-level signal. At this point, the switching device T13 in the second reset control signal generation circuit P GOA is in the on state, and the high-level signal transmitted by the first power line VGH is written into the nodes N1 and N7, thereby turning off the switching device T10 in the second reset control signal generation circuit P GOA, that is, the second reset control signal generation circuit P GOA cannot output the low-level signal, i.e., outputs the high-level signal. At this point, the switching device T1 in the pixel drive circuit shown in FIG. 3 remains turned off, preventing a noise signal from the initialization signal line init1 from being transmitted to the light-emitting device. Afterwards, the timing control module controls the reset signal line PCX of the second reset control signal generation circuit P GOA to transmit the high-level signal. The time of the reset signal line PCX transmitting the high-level signal is earlier than the time of the display enable signal TE being sent to the data signal drive module or earlier than the power-on time of the data signal drive module. Thus, in the present embodiment, it can be ensured that a noise signal on the initialization level lines in the pixel drive circuit cannot be transmitted to the light-emitting device during a certain period prior to display, thereby ensuring that the display panel does not have a screen flickering problem.

In some embodiments, the timing control module controls the enable signal line NSTV of the first write signal generation circuit Ngate GOA to be powered on and transmits a low-level signal. The time of the enable signal line NSTV of the first write signal generation circuit Ngate GOA transmitting the low-level signal is earlier than the time of the display enable signal TE being sent to the data signal drive module. Then, upon the data signal drive module outputting the pixel data of at least one frame of the black image, the timing control module controls the enable signal line NSTV of the first write signal generation circuit Ngate GOA to transmit a clock pulse signal.

Continuing to refer to FIGS. 7 and 9, in an example, the timing control module first controls the enable signal line NSTV of the first write signal generation circuit Ngate GOA to be powered on. At this point, the enable signal line NSTV of the first write signal generation circuit Ngate GOA transmits a high-level signal. In the case that three scan periods following power-on, the timing control module controls the data signal drive module to be powered on. Upon being powered on, the data signal drive module first outputs pixel data for three frames of black images, and then outputs pixel data for an actual display image. Then, the timing control module controls the enable signal line NSTV of the first write signal generation circuit Ngate GOA to transmit a clock pulse signal.

Thus, by powering on the enable signal line NSTV and transmitting the high-level signal, in response to the switching devices T1 and T12 in the first write signal generation circuit Ngate GOA being turned on, the potentials at the nodes N1 and N7 are set to a high level, thereby turning off the switching device T10 in the first write signal generation circuit Ngate GOA. Accordingly, the output terminal OUT of the first write signal generation circuit Ngate GOA cannot output a low-level signal, i.e., outputs the high-level signal.

Because the switching device T2 in the pixel drive circuit shown in FIG. 2 or FIG. 3 is controlled by the output signal of the first write signal generation circuit Ngate GOA, at this point, the switching device T2 in the pixel drive circuit remains in the on state, enabling the potentials at the nodes N1 and N3 in the pixel drive circuit to be equal, that is, the switching device T3 remains turned off and cannot drive the light-emitting device to emit light, i.e., a screen flickering problem of the display panel is avoided.

In some embodiments, upon controlling the enable signal line NSTV of the first write signal generation circuit Ngate GOA to be powered on, the timing control module controls the clock signal line NCK/NCB of the first write signal generation circuit Ngate GOA to transmit a low-level signal for at least one scan period, and then, control the clock signal line NCK/NCB of the first write signal generation circuit Ngate GOA to transmit a clock pulse signal. The time of the clock signal line NCK/NCB of the first write signal generation circuit Ngate GOA starting to transmit the clock pulse signal is earlier than the time of the display enable signal TE being sent to the data signal drive module.

Continuing to refer to FIGS. 7 and 9, the timing control module controls the enable signal line NSTV of the first write signal generation circuit Ngate GOA to be powered on. At this point, the enable signal line NSTV of the first write signal generation circuit Ngate GOA transmits a low-level signal. Then, the timing control module controls the first clock signal line NCK of the first write signal generation circuit Ngate GOA to be powered on and transmits a low-level signal for one scan period, and controls the second clock signal line NCB to be powered on and transmits a high-level signal for one scan period. At this point, the switching devices T1 and T12 in the first write signal generation circuit Ngate GOA are in the on state, and the low-level signal transmitted by the enable signal line NSTV is written into nodes N1 and N7, thereby enabling the switching device T10 in the first write signal generation circuit Ngate GOA to be in the on state. The node NI is at a low level, and at this point, the switching device T8 is turned on. A high-level signal from the first power line VGH is written into a node N4. In addition, the second clock signal line NCB transmits the high-level signal, and at this point, the switching device T7 is turned off. Finally, the node N4 is at a high level, thereby turning off the switching device T9, that is, the first write signal generation circuit Ngate GOA outputs the low-level signal. At this point, the switching device T2 in the pixel drive circuit remains turned off, which prevents a noise signal transmitted by the initialization signal line init1 from being transmitted to the light-emitting device, i.e., a screen flickering problem of the display panel is avoided.

In some embodiments, upon the enable signal line NSTV of the first write signal generation circuit Ngate GOA being powered on, the timing control module controls the reset signal line NCX of the first write signal generation circuit Ngate GOA to transmit a high-level signal. Continuing to refer to FIGS. 7 and 9, at this point, a switching device T13 in the first write signal generation circuit Ngate GOA is in the off state, and the high-level signal transmitted by the first power line VGH cannot be written into the node N1. Because the first clock signal line NCK of the first write signal generation circuit Ngate GOA transmits a low-level signal for one scan period and the second clock signal line NCB transmits the high-level signal for one scan period, at this point, the switching device T10 of the first write signal generation circuit Ngate GOA is turned on, that is, the first write signal generation circuit Ngate GOA outputs the low-level signal. At this point, the switching device T2 in the pixel drive circuit remains turned off, which prevents a noise signal transmitted by the initialization signal line init1 from being transmitted to the light-emitting device, i.e., a screen flickering problem of the display panel is avoided.

In some embodiments, the timing control module controls the enable signal line GSTV of the second write signal generation circuit Gate GOA to be powered on and the enable signal line GSTV to transmit a high-level signal. The power-on time of the enable signal line GSTV of the second write signal generation circuit Gate GOA is earlier than the time of the display enable signal TE being sent to the data signal drive module. Then, upon the data signal drive module outputting the pixel data of at least one frame of the black image, the timing control module controls the enable signal line GSTV of the second write signal generation circuit Gate GOA to transmit a clock pulse signal. The time of the enable signal line GSTV of the second write signal generation circuit Gate GOA starting to transmit the clock pulse signal is earlier than the time of the display enable signal TE being sent to the data signal drive module.

In some embodiments, upon the enable signal line GSTV of the second write signal generation circuit Gate GOA being powered on for at least one scan period, the clock signal line GCK/GCB of the second write signal generation circuit Gate GOA is controlled to transmit a low-level signal.

Continuing to refer to FIGS. 8 and 9, upon the enable signal line GSTV of the second write signal generation circuit Gate GOA being powered on and the enable signal line GSTV transmits a high-level signal, in response to the clock signal line GCK/GCB of the second write signal generation circuit Gate GOA being controlled to transmit the low-level signal, a high level is written into nodes N1 and N4 of the second write signal generation circuit Gate GOA. At this point, a switching device T5 of the second write signal generation circuit Gate GOA is turned off. The low-level signal transmitted by the second power line VGL is written into the node N2. At this point, the switching device T4 is turned on, and the second write signal generation circuit Gate GOA outputs the high-level signal transmitted by the first power line VGH. Because the switching device T4 in the pixel drive circuit is controlled by the output signal of the second write signal generation circuit Gate GOA and is turned off, pixel data cannot be written to the node N2 in the pixel drive circuit. Thus, the light-emitting device is prevented from being illuminated in response to the pixel data being the low-level signal and the switching device T4 being turned on, thereby avoiding a screen flickering problem. In some embodiments, continuing to refer to FIGS. 2 to 8, the timing control module controls the first power line VGH of the scan signal drive module to transmit the high-level signal, and controls the second power line VGL of the scan signal drive module to transmit the low-level signal. The first power line VGH and the second power line VGL are powered on simultaneously, earlier than the power-on time of the clock signal line of the scan signal drive module. Continuing to refer to FIG. 9, the first power line VGH and the second power line VGL are powered on five scan periods earlier than the power-on time of the clock signal line of the scan signal drive module. Thus, it can be ensured that the first power line VGH outputs the valid high-level signal and the second power line VGL outputs the valid low-level signal.

In some embodiments, continuing to refer to FIGS. 2 and 3, the timing control module controls the first drive power line ELVDD in the pixel drive circuit of each pixel unit to be powered on and transmits a high-level signal. The timing control module controls the second drive power line ELVSS in the pixel drive circuit of each pixel unit to be powered on and transmits a low-level signal. The power-on time of the first drive power line ELVDD and the power-on time of the second drive power line ELVSS are later than the time of the clock signal line GCK/GCB in the pixel drive circuit of each pixel unit starting to transmit a clock pulse. Continuing to refer to FIG. 9, the timing control module sequentially controls the clock signal line ECK/ECB to transmit the clock pulse signal, the first drive power line ELVDD to transmit the high-level signal, the second drive power line ELVSS to transmit the low-level signal, and the enable signal line ESTV to transmit the clock pulse signal. Thus, in the present embodiment, a screen flickering problem caused by the first drive power line ELVDD being powered on too early can be avoided. For example, in response to the light-emitting control signal generation circuit EM GOA outputting the low-level signal, the switching devices T5 and T6 in the pixel drive circuit are turned on. In the case that the first drive power line ELVDD and the second drive power line ELVSS have been powered on, the light-emitting device emits light, thereby leading to the screen flickering problem.

In some embodiments, the timing control module controls the first pixel data power line GSP to be powered on and transmits a first preset level signal. In addition, the timing control module controls the second pixel data power line GMP to be powered on and transmit a second preset level signal. The power-on time of the first pixel data power line GSP and the power-on time of the second pixel data power line GMP are at least two scan periods earlier than the power-on time of the enable signal line ESTV of the light-emitting control signal generation circuit EM GOA. Continuing to refer to FIG. 9, the first pixel data power line GSP provides a first preset level signal VGSP, and the second pixel data power line GMP provides a second preset level signal VGMP; and the range of pixel data values is [VGSP, VGMP]. It can be understood that both the first preset level signal VGSP and the second preset level signal VGMP are level signals greater than 0V.

Continuing to refer to FIG. 9, the frequency of the clock pulse signal transmitted by the enable signal lines (ESTV/PSTV/HSTV) is the same as or different from the frequency of the clock pulse signal transmitted by the clock signal lines (ECK/ECB), which is set according to specific scenarios.

Based on the display panel provided by the embodiments of the present disclosure, a method for controlling display is provided according to the embodiments of the present disclosure. The method is applicable to a display panel; the display panel includes: a timing control module, a pixel array, and a data signal drive module; each pixel unit in the pixel array includes a light-emitting device and a pixel drive circuit configured to drive the light-emitting device to emit light; and the method includes: sending a display enable signal to the data signal drive module, the display enable signal being configured to control the data signal drive module to be powered on and output pixel data of at least one frame of a black image.

Optionally, the display panel further includes a scan signal drive module, the scan signal drive module including a light-emitting control signal generation circuit and a first write signal generation circuit; and the method further includes: prior to sending the display enable signal to the data signal drive module, controlling an enable signal line of the light-emitting control signal generation circuit to be powered on and transmitting a second level signal; upon the data signal drive module outputting the pixel data of the at least one frame of the black image, controlling the enable signal line of the light-emitting control signal generation circuit to transmit a clock pulse signal; in response to the enable signal line of the light-emitting control signal generation circuit being powered on, controlling a reset signal line of the light-emitting control signal generation circuit to transmit a first level signal for at least one scan period; controlling the reset signal line of the light-emitting control signal generation circuit to transmit the second level signal, wherein a time of the reset signal line transmitting the second level signal is earlier than a time of the display enable signal being sent to the data signal drive module; controlling an enable signal line of the first write signal generation circuit to be powered on and transmitting a first level signal, wherein a time of the enable signal line of the first write signal generation circuit transmitting the first level signal is earlier than the time of the display enable signal being sent to the data signal drive module; and upon the data signal drive module outputting the pixel data of at least one frame of the black image, controlling the enable signal line of the first write signal generation circuit to transmit a clock pulse signal.

Optionally, the method further includes: in response to controlling the enable signal line of the light-emitting control signal generation circuit to transmit the second level signal, controlling a clock signal line of the light-emitting control signal generation circuit to be powered on and transmitting the first level signal for at least one scan period; and prior to sending the display enable signal to the data signal drive module, controlling the clock signal line of the light-emitting control signal generation circuit to transmit a clock pulse signal.

It should be noted that the method embodiments shown in the embodiments correspond to the contents of the display panel embodiments, and reference is made to the contents of the above display panel embodiments, which are not repeated herein.

Based on the method for controlling display provided by the embodiments of the present disclosure, an apparatus for controlling display is further provided according to the embodiments of the present disclosure. The apparatus is applicable to a display panel; the display panel includes a timing control module, a pixel array, and a data signal drive module; each pixel unit in the pixel array includes a light-emitting device and a pixel drive circuit configured to drive the light-emitting device to emit light; and the apparatus includes: a display enable signal sending module, configured to send a display enable signal to the data signal drive module, the display enable signal being configured to control the data signal drive module to be powered on and output pixel data of at least one frame of a black image.

Optionally, the apparatus further includes: an initialization signal line power-on module, configured to, in response to the display enable signal being sent, control an initialization signal line in the pixel drive circuit of each pixel unit to be powered on, and control a level of the initialization signal line to be at a first level.

Optionally, the display panel further includes a scan signal drive module, the scan signal drive module including a light-emitting control signal generation circuit. The apparatus further includes: an enable signal line power-on module, configured to, before the display enable signal is sent to the data signal drive module, control an enable signal line of the light-emitting control signal generation circuit to be powered on and transmit a second level signal; and a pulse signal transmission module, configured to, upon the data signal drive module outputting the pixel data of the at least one frame of the black image, control the enable signal line of the light-emitting control signal generation circuit to transmit a clock pulse signal.

Optionally, the apparatus further includes: a clock signal line power-on module, configured to, in response to the enable signal line of the light-emitting control signal generation circuit being controlled to transmit the second level signal, control a clock signal line of the light-emitting control signal generation circuit to be powered on and transmit the first level signal for at least one scan period; and a pulse signal transmission module, configured to, before the display enable signal is sent to the data signal drive module, control the clock signal line of the light-emitting control signal generation circuit to transmit a clock pulse signal.

Optionally, the apparatus further includes: a reset signal line power-on module, configured to, in response to the enable signal line of the light-emitting control signal generation circuit being powered on, control a reset signal line of the light-emitting control signal generation circuit to transmit the first level signal for at least one scan period; and a level signal output module, configured to control the reset signal line of the light-emitting control signal generation circuit to transmit the second level signal, wherein a time of the reset signal line transmitting the second level signal is earlier than a time of the display enable signal being sent to the data signal drive module.

Optionally, the scan signal drive module includes a first reset control signal generation circuit, and the first reset control signal generation circuit and the light-emitting control signal generation circuit are identical in circuit structure. The apparatus further includes: a signal line power-on control module, configured to control an enable signal line, a clock signal line and a reset signal line of the first reset control signal generation circuit to be powered on; and power-on timings of at least one pair of: the enable signal line of the first reset control signal generation circuit and the enable signal line of the light-emitting control signal generation circuit, the clock signal line of the first reset control signal generation circuit and the clock signal line of the light-emitting control signal generation circuit, and the reset signal line of the first reset control signal generation circuit and the reset signal line of the light-emitting control signal generation circuit are identical.

Optionally, the scan signal drive module includes a second reset control signal generation circuit, and the second reset control signal generation circuit and the light-emitting control signal generation circuit are identical in circuit structure. The apparatus further includes: a signal line power-on control module, configured to control an enable signal line, a clock signal line and a reset signal line of the second reset control signal generation circuit to be powered on; and power-on timings of at least one pair of: the enable signal line of the second reset control signal generation circuit and the enable signal line of the light-emitting control signal generation circuit, the clock signal line of the second reset control signal generation circuit and the clock signal line of the light-emitting control signal generation circuit, and the reset signal line of the second reset control signal generation circuit and the reset signal line of the light-emitting control signal generation circuit are identical.

Optionally, the scan signal drive module includes a first write signal generation circuit. The apparatus includes: an enable signal line power-on module, configured to control an enable signal line of the first write signal generation circuit to be powered on and transmit a first level signal, wherein a time of the enable signal line of the first write signal generation circuit transmitting the first level signal is earlier than a time of the display enable signal being sent to the data signal drive module; and a pulse signal transmission module, configured to, upon the data signal drive module outputting the pixel data of at least one frame of the black image, control the enable signal line of the first write signal generation circuit to transmit a clock pulse signal.

Optionally, the apparatus further includes: a level signal transmission module, configured to, upon the enable signal line of the first write signal generation circuit being controlled to be powered on, control a first clock signal line of the first write signal generation circuit to transmit the first level signal for at least one scan period and control a second clock signal line of the first write signal generation circuit to transmit the second level signal for at least one scan period; and a pulse signal transmission module, configured to control the first clock signal line and the second clock signal line of the first write signal generation circuit to transmit clock pulse signals, wherein a time of the first clock signal line of the first write signal generation circuit starting to transmit the clock pulse signal and a time of the second clock signal line of the first write signal generation circuit starting to transmit the clock pulse signal are earlier than a time of the display enable signal being sent to the data signal drive module.

Optionally, the apparatus further includes a level signal transmission module, configured to, upon the enable signal line of the first write signal generation circuit being powered on, control a reset signal line of the first write signal generation circuit to transmit

Optionally, the display panel further includes a scan signal drive module; and the scan signal drive module includes a second write signal generation circuit. The apparatus includes: an enable signal line power-on module, configured to control an enable signal line of the second write signal generation circuit to be powered on and the enable signal line to transmit a second level signal, wherein a power-on time of the enable signal line of the second write signal generation circuit is earlier than a time of the display enable signal being sent to the data signal drive module; and a pulse signal transmission module, configured to, upon the data signal drive module outputting the pixel data of at least one frame of the black image, control the enable signal line of the second write signal generation circuit to transmit a clock pulse signal, wherein a time of the enable signal line of the second write signal generation circuit starting to transmit the clock pulse signal is earlier than the time of the display enable signal being sent to the data signal drive module.

Optionally, the apparatus further includes a level signal transmission module, configured to, upon the enable signal line of the second write signal generation circuit being powered on for at least one scan period, control a clock signal line of the second write signal generation circuit to transmit the first level signal.

Optionally, the display panel further includes a scan signal drive module. The apparatus includes: a first level signal transmission module, configured to control a first power line of the scan signal drive module to transmit a second level signal; and a second level signal transmission module, configured to control a second power line of the scan signal drive module to transmit a first level signal, wherein the first power line and the second power line are powered on simultaneously, earlier than a power-on time of a clock signal line of the scan signal drive module.

Optionally, the apparatus further includes: a first drive power line power-on module, configured to control a first drive power line in the pixel drive circuit of each pixel unit to be powered on and transmit a second level signal; and a second drive power line power-on module, configured to control a second drive power line in the pixel drive circuit of each pixel unit to be powered on and transmit a first level signal, wherein a power-on time of the first drive power line and a power-on time of the second drive power line are later than a time of a clock signal line in the pixel drive circuit of each pixel unit starting to transmit a clock pulse signal.

Optionally, the apparatus further includes: a first pixel power line power-on module, configured to control a first pixel data power line to be powered on and transmit a first preset level signal; and a second pixel power line power-on module, configured to control a second pixel data power line to be powered on and transmit a second preset level signal, wherein a power-on time of the first pixel data power line and a power-on time of the second pixel data power line GMP are at least two scan periods earlier than a power-on time of an enable signal line of a light-emitting control signal generation circuit.

It should be noted that the apparatus shown in the embodiment corresponds to the content of the method embodiment, and reference is made to the content of the above method embodiment, which are not repeated herein.

In some possible embodiments, a display panel is provided, and includes: a timing control module, a scan signal drive module, a pixel array, and a data signal drive module. Each pixel unit in the pixel array includes a light-emitting device and a pixel drive circuit configured to drive the light-emitting device to emit light. The timing control module is configured to execute the display control method as described above.

In some possible embodiments, a display device is provided, and includes the display panel as described above.

The terms used in the present disclosure are for the purpose of describing particular embodiments only and are not intended to limit the present disclosure. Unless otherwise defined, the technical terms or scientific terms used in the present disclosure shall be taken to mean the ordinary meanings as understood by the ordinary skill in the art to which the present disclosure belongs. Terms such as “a” or “one” used in the Description of the present disclosure and the appended claims do not indicate the quantity limit, but indicate the existence of at least one. The term “a plurality of” indicates two or more. The terms “comprise/include” or “contain” and the like are intended to mean that the elements or objects before the terms cover the elements or objects or equivalents listed after the terms, without excluding other elements or objects. The terms “connected”, “coupled” and the like are not limited to physical or mechanical connections, and may include electrical connection, and the connection may be direct or indirect. The singular forms “a/an”, “the” and “said” used in the Description of the present disclosure and the appended claims are intended to include the plural forms unless the context clearly indicates otherwise. It should also be understood that the term “and/or” as used herein refers to and encompasses any and all possible combinations of one or more of associated listed items.

For the method embodiments, because they basically correspond to the apparatus embodiments, reference may be made to the relevant descriptions in the apparatus embodiments for related parts. The method embodiments and the apparatus embodiments are complementary to each other.

The foregoing descriptions are merely preferred embodiments of the present disclosure, and are not intended to limit the present disclosure. All modifications, equivalent substitutions, improvements, etc., made within the spirit and principles of the present disclosure shall be included in the scope of protection of the present disclosure.

1. A display panel, comprising: a timing control module, a pixel array, and a data signal drive module,
wherein each pixel unit in the pixel array comprises a light-emitting device and a pixel drive circuit configured to drive the light-emitting device to emit light, the timing control module is configured to send a display enable signal to the data signal drive module, and the display enable signal is configured to control the data signal drive module to be powered on and output pixel data of at least one frame of a black image.

2. The display panel according to claim 1, wherein the timing control module is further configured to:
in response to sending the display enable signal, control an initialization signal line in the pixel drive circuit of each pixel unit to be powered on; and control a level of the initialization signal line be to at a first level.

3. The display panel according to claim 1, wherein the display panel further comprises a scan signal drive module, wherein the scan signal drive module comprises a light-emitting control signal generation circuit;
the timing control module is further configured to, prior to sending the display enable signal to the data signal drive module, control an enable signal line of the light-emitting control signal generation circuit to be powered on and transmit a second level signal; and
the timing control module is further configured to, upon the data signal drive module outputting the pixel data of the at least one frame of the black image, control the enable signal line of the light-emitting control signal generation circuit to transmit a clock pulse signal.

4. The display panel according to claim 3, wherein the timing control module is further configured to, in response to controlling the enable signal line of the light-emitting control signal generation circuit to transmit the second level signal, control a clock signal line of the light-emitting control signal generation circuit to be powered on and transmit a first level signal for at least one scan period; and
the timing control module is further configured to, prior to sending the display enable signal to the data signal drive module, control the clock signal line of the light-emitting control signal generation circuit to transmit the clock pulse signal.

5. The display panel according to claim 3, wherein
the timing control module is further configured to, in response to the enable signal line of the light-emitting control signal generation circuit being powered on, control a reset signal line of the light-emitting control signal generation circuit to transmit a first level signal for at least one scan period; and
the timing control module is further configured to control the reset signal line of the light-emitting control signal generation circuit to transmit the second level signal, wherein a time of the reset signal line transmitting the second level signal is earlier than a time of the display enable signal being sent to the data signal drive module.

6. The display panel according to claim 3,
wherein the scan signal drive module comprises a first reset control signal generation circuit, wherein the first reset control signal generation circuit and the light-emitting control signal generation circuit are identical in circuit structure;
the timing control module is further configured to control an enable signal line, a clock signal line and a reset signal line of the first reset control signal generation circuit to be powered on; and
power-on timings of at least one pair of: the enable signal line of the first reset control signal generation circuit and the enable signal line of the light-emitting control signal generation circuit, the clock signal line of the first reset control signal generation circuit and the clock signal line of the light-emitting control signal generation circuit, and the reset signal line of the first reset control signal generation circuit and the reset signal line of the light-emitting control signal generation circuit are identical.

7. The display panel according to claim 3, wherein the scan signal drive module comprises a second reset control signal generation circuit, wherein the second reset control signal generation circuit and the light-emitting control signal generation circuit are identical in circuit structure;
the timing control module is further configured to control an enable signal line, a clock signal line and a reset signal line of the second reset control signal generation circuit to be powered on; and
power-on timings of at least one pair of: the enable signal line of the second reset control signal generation circuit and the enable signal line of the light-emitting control signal generation circuit, the clock signal line of the second reset control signal generation circuit and the clock signal line of the light-emitting control signal generation circuit, and the reset signal line of the second reset control signal generation circuit and the reset signal line of the light-emitting control signal generation circuit are identical.

8. The display panel according to claim 3, wherein the scan signal drive module comprises a first write signal generation circuit;
the timing control module is further configured to control an enable signal line of the first write signal generation circuit to be powered on and transmit a first level signal, wherein a time of the enable signal line of the first write signal generation circuit transmitting the first level signal is earlier than a time of the display enable signal being sent to the data signal drive module; and
the timing control module is further configured to, upon the data signal drive module outputting the pixel data of the at least one frame of the black image, control the enable signal line of the first write signal generation circuit to transmit the clock pulse signal.

9. The display panel according to claim 8, wherein
the timing control module is further configured to, upon controlling the enable signal line of the first write signal generation circuit to be powered on, control a first clock signal line of the first write signal generation circuit to transmit the first level signal for at least one scan period and control a second clock signal line of the first write signal generation circuit to transmit the second level signal for at least one scan period; and
the timing control module is further configured to control the first clock signal line and the second clock signal line of the first write signal generation circuit to transmit clock pulse signals, wherein a time of the first clock signal line of the first write signal generation circuit starting to transmit the clock pulse signal and a time of the second clock signal line of the first write signal generation circuit starting to transmit the clock pulse signal are earlier than a time of the display enable signal being sent to the data signal drive module.

10. The display panel according to claim 8, wherein
the timing control module is further configured to, upon the enable signal line of the first write signal generation circuit being powered on, control a reset signal line of the first write signal generation circuit to transmit the second level signal.

11. The display panel according to claim 1, further comprising a scan signal drive module, wherein the scan signal drive module comprises a second write signal generation circuit;
the timing control module is further configured to control an enable signal line of the second write signal generation circuit to be powered on and the enable signal line to transmit a second level signal, wherein a power-on time of the enable signal line of the second write signal generation circuit is earlier than a time of the display enable signal being sent to the data signal drive module; and
the timing control module is further configured to, upon the data signal drive module outputting the pixel data of the at least one frame of the black image, control the enable signal line of the second write signal generation circuit to transmit a clock pulse signal, wherein a time of the enable signal line of the second write signal generation circuit starting to transmit the clock pulse signal is earlier than the time of the display enable signal being sent to the data signal drive module.

12. The display panel according to claim 11, wherein
the timing control module is further configured to, upon the enable signal line of the second write signal generation circuit being powered on for at least one scan period, control a clock signal line of the second write signal generation circuit to transmit the first level signal.

13. The display panel according to claim 1, further comprising: a scan signal drive module,
wherein the timing control module is further configured to control a first power line of the scan signal drive module to transmit a second level signal;
the timing control module is further configured to control a second power line of the scan signal drive module to transmit a first level signal; and
the first power line and the second power line are powered on simultaneously, earlier than a power-on time of a clock signal line of the scan signal drive module.

14. The display panel according to claim 1, wherein
the timing control module is further configured to control a first drive power line in the pixel drive circuit of each pixel unit to be powered on and transmit a second level signal;
the timing control module is further configured to control a second drive power line in the pixel drive circuit of each pixel unit to be powered on and transmit a first level signal; and
a power-on time of the first drive power line and a power-on time of the second drive power line are later than a time of a clock signal line in the pixel drive circuit of each pixel unit starting to transmit a clock pulse signal.

15. The display panel according to claim 1, wherein
the timing control module is further configured to control a first pixel data power line to be powered on and transmit a first preset level signal, and control a second pixel data power line to be powered on and transmit a second preset level signal; and
a power-on time of the first pixel data power line and a power-on time of the second pixel data power line are at least two scan periods earlier than a power-on time of an enable signal line of a light-emitting control signal generation circuit.

16. A method for controlling display, wherein the method is applicable to a display panel; the display panel comprises a timing control module, a pixel array, and a data signal drive module, wherein each pixel unit in the pixel array comprises a light-emitting device and a pixel drive circuit configured to drive the light-emitting device to emit light, and the method comprises:
sending a display enable signal to the data signal drive module, wherein the display enable signal is configured to control the data signal drive module to be powered on and output pixel data of at least one frame of a black image.

17. The method according to claim 16, wherein the display panel further comprises a scan signal drive module, the scan signal drive module comprises a light-emitting control signal generation circuit and a first write signal generation circuit, and the method further comprises:
prior to sending the display enable signal to the data signal drive module, controlling an enable signal line of the light-emitting control signal generation circuit to be powered on and transmitting a second level signal;
upon the data signal drive module outputting the pixel data of the at least one frame of the black image, controlling the enable signal line of the light-emitting control signal generation circuit to transmit a clock pulse signal;
in response to the enable signal line of the light-emitting control signal generation circuit being powered on, controlling a reset signal line of the light-emitting control signal generation circuit to transmit a first level signal for at least one scan period; and
controlling the reset signal line of the light-emitting control signal generation circuit to transmit the second level signal, wherein a time of the reset signal line transmitting the second level signal is earlier than a time of the display enable signal being sent to the data signal drive module;
controlling an enable signal line of the first write signal generation circuit to be powered on and transmitting the first level signal, wherein a time of the enable signal line of the first write signal generation circuit transmitting the first level signal is earlier than the time of the display enable signal being sent to the data signal drive module; and
upon the data signal drive module outputting the pixel data of the at least one frame of the black image, controlling the enable signal line of the first write signal generation circuit to transmit the clock pulse signal.

18. The method according to claim 17, further comprising:
in response to controlling the enable signal line of the light-emitting control signal generation circuit to transmit the second level signal, controlling a clock signal line of the light-emitting control signal generation circuit to be powered on and transmitting the first level signal for at least one scan period; and
prior to sending the display enable signal to the data signal drive module, controlling the clock signal line of the light-emitting control signal generation circuit to transmit the clock pulse signal.

19. (canceled)

20. A display device, comprising: a display panel, wherein the display comprises: a timing control module, a pixel array, and a data signal drive module,
wherein each pixel unit in the pixel array comprises a light-emitting device and a pixel drive circuit configured to drive the light-emitting device to emit light, the timing control module is configured to send a display enable signal to the data signal drive module, and the display enable signal is configured to control the data signal drive module to be powered on and output pixel data of at least one frame of a black image.

21. The display device according to claim 20, wherein the timing control module is further configured to:
in response to sending the display enable signal, control an initialization signal line in the pixel drive circuit of each pixel unit to be powered on; and control a level of the initialization signal line be to at a first level.
